(19) United States
(12) Patent Application Publication
(10) Pub. No.: US 2007/0250590 A1
(43) Pub. Date: Oct. 25, 2007

(54) Ad-hoc proxy for discovery and retrieval of dynamic data such as a list of active devices

(75) Inventors: Eliot J. Flannery, Redmond, WA (US); Henry L. Sanders, Kirkland, WA (US); Sandeep K. Singhal, Kirkland, WA (US); Todd R. Manion, Redmond, WA (US); Upshur W. Parks, Bothell, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/409,100

(22) Filed: Apr. 21, 2006

(51) Int. Cl. G06F 15/16; G06F 15/173

(52) U.S. Cl. 709/217; 709/223

(57) ABSTRACT

The claimed method and system describes a dynamic construction of a virtual proxy using a set of virtual proxy hosts. The virtual proxy hosts may maintain a shared data store that contains a record of discovered services on a network. The virtual proxy hosts may work together to respond to discovery requests using the shared data store. Clients on a network having a virtual proxy host may be limited to unicast discovery requests with the virtual proxy host, thereby reducing broadcast traffic.

### BACKGROUND

Broadcast-based discovery protocols, such as Web Services Discovery (WS-Discovery) protocol, may consume considerable bandwidth on large subnets or subnets that contain many services and/or requesters. In open networks that implement a broadcast based discovery protocol, a broadcast storm may occur when too many services/requestors are sending probe and/or resolve messages at the same time. The storm may overwhelm a communication system and cause delay in communication inside and outside of a discovery process. While some broadcast protocols may have mechanisms to reduce network traffic, such as message wait triggers to create gaps in communications, large subnets having many devices may still suffer from data storms and communication failures.

Some broadcast based discovery protocols may support a hosted discovery proxy that maintains a store of available WS-Discovery services on a dedicated server. Instead of sending a network wide probe message to discover services, a host may simply interact with a proxy to perform its service resolution process. The proxy may reduce network traffic by storing discovery information so that a host may simply perform a unicast query to the proxy to perform discovery.

While use of a proxy may reduce network traffic, a proxy may require that an enterprise explicitly deploy a host server, which may add network deployment and administration costs.

### SUMMARY

The claimed method and system provides an ad hoc, virtual proxy using a subnet of hosts that manage a shared data store. The claimed method and system may overlay a subnet of virtual proxy hosts on top of a larger network of entities which may include legacy devices that are unable of joining the virtual proxy subnet. The claimed method and system enables an ad hoc proxy to be created based on client participation in a local area network (LAN).

In one embodiment, an ad-hoc proxy may be used for discovering and retrieving dynamic data, providing resolution services, and advertising services on a LAN.

In one embodiment, the claimed ad-hoc proxy may be used for managing device data in a WS-Discovery environment and/or device data in an Simple Service Discovery Protocol (SSDP) environment.

### DRAWINGS

FIG. 1 illustrates a block diagram of a computing system that may operate in accordance with the claims;

FIG. 2 illustrates a unicast polling process;

FIG. 3 illustrates a multicast polling process;

FIG. 4 illustrates a general discovery process using a broadcast based discovery protocol;

FIG. 5 illustrates a general broadcast based discovery system using a discovery proxy;

FIG. 6 illustrates a general WS-Discovery discovery process involving a discovery proxy;

FIG. 7 illustrates a general system embodiment of ad hoc proxy or virtual proxy;

FIG. 8 illustrates a general distributed hash table (DHT) which may be used in one embodiment; and

FIG. 9 illustrates virtual host characteristics.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

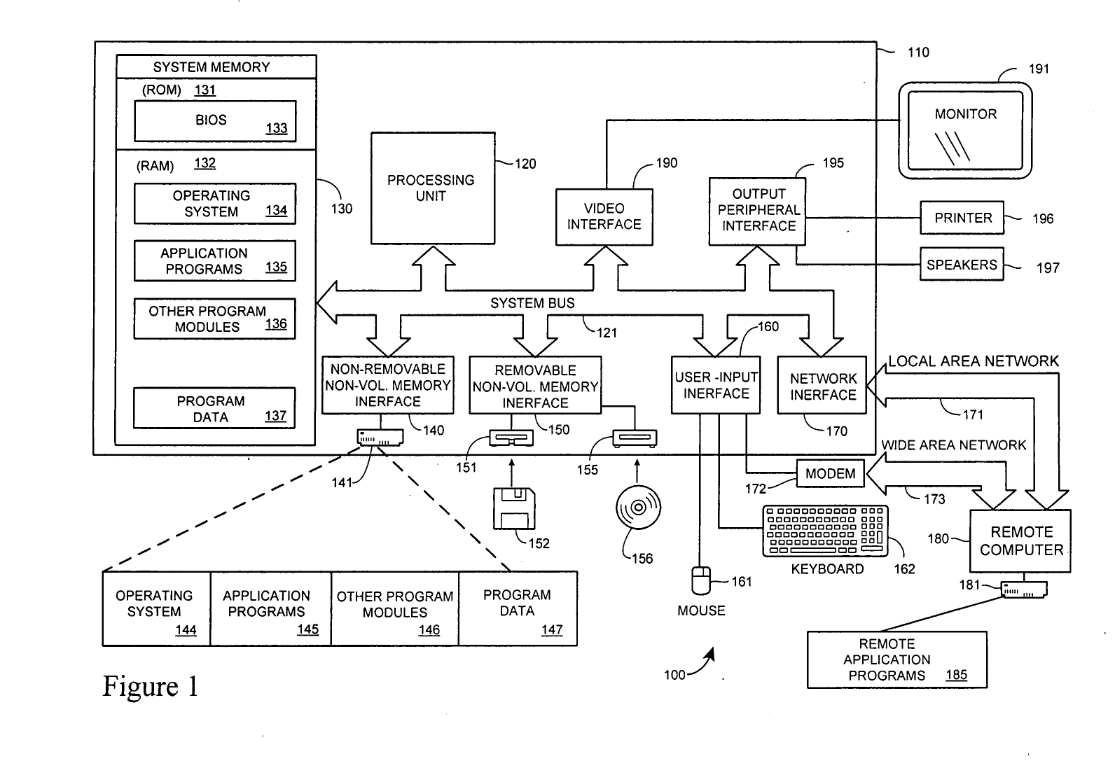

FIG. 1 illustrates an example of a suitable computing system environment 100 on which a system for the blocks of the claimed method and apparatus may be implemented. The computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100.

The blocks of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The blocks of the claimed method and apparatus may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the blocks of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media may be any available media that may be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components may either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not illustrated) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections illustrated are exemplary and other means of establishing a communications link between the computers may be used.

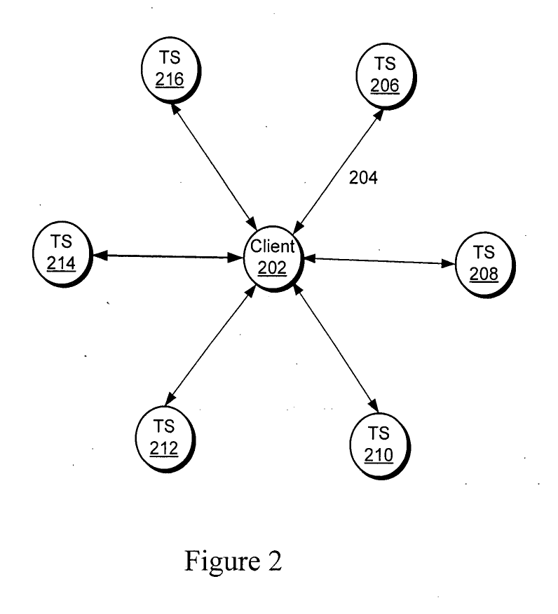

Discovery may involve a client searching for one or more target services. This search may involve a polling process in which a client transmits messages to possible target services until a match is found. FIG. 2 illustrates a unicast polling process in which a client 202 may transmit a series of unicast messages 204 to potential target services 206-216.

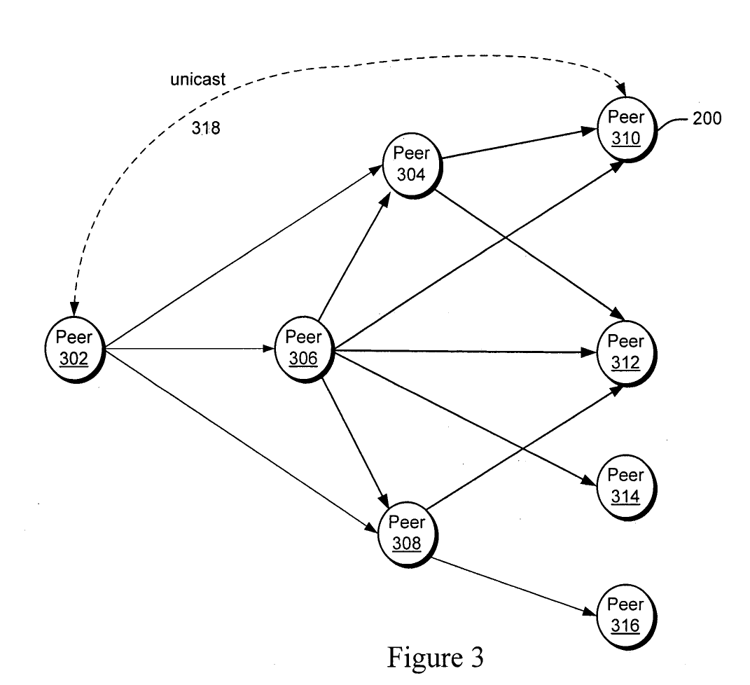

Alternatively, FIG. 3 illustrates that a client 302 may send a multicast discovery request to a multicast group 304-316 to find a target service. In this situation, a client may send a message which is further propagated by receivers throughout a network. Once a target service, e.g., 310, responds, the client 302 may communicate directly, e.g., via unicast, with the discovered target 310, as illustrated by path 318.

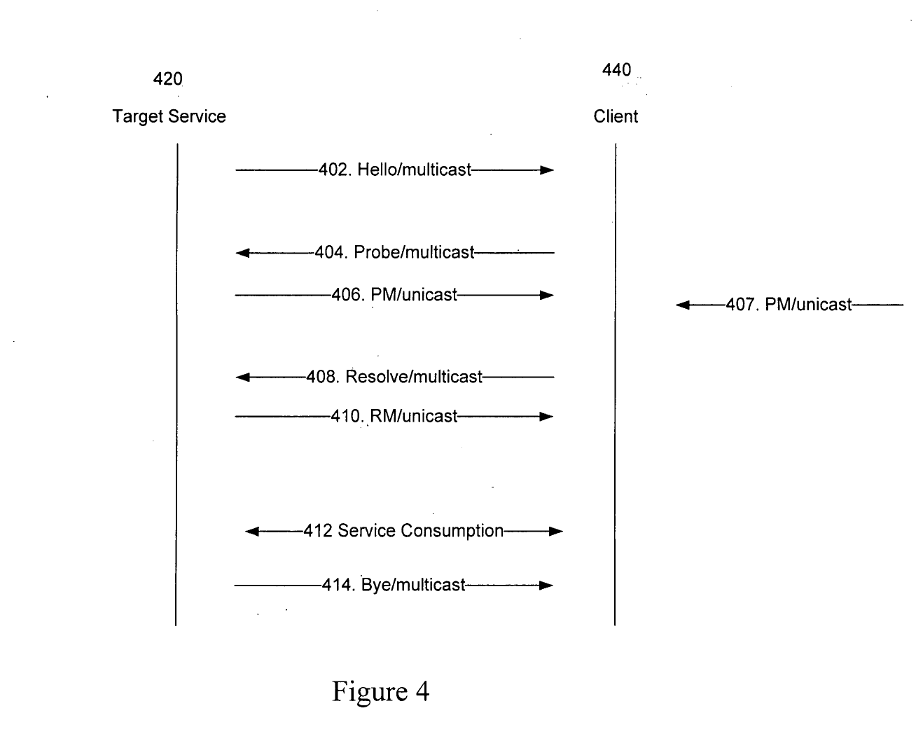

FIG. 4 illustrates a general discovery process using a broadcast based discovery protocol, which may be a Web Services Dynamic Discovery (WS-Discovery) protocol. Other broadcast based protocols may also operate in the same general manner. A discovery protocol such as WS-Discovery may define two polling type operations, a probe and resolve operation, to locate Web services on a network. A target service 420 may receive a multicast probe 404 at any time and send a unicast probe match (PM) 406 if the target service 420 matches a probe. The probe match may indicate that the service is capable of addressing the client's need. Other matching target services may also send a unicast PM 407. Thereafter, a client and service may interact directly 412 (e.g., via unicast).

To locate a target service by name, a client 440 may send a resolution request message 408, or resolve message, to the same multicast group. A target service 420 may receive a multicast resolve 408 at any time and send a unicast resolve Match (RM) 410, or resolve response, if it is the target of a resolve. The resolve message may be used when a service is to be located by name. The resolve match from a service may contain address and other identifying information such that the client may be able to identify and communicate with the service. The responses may be sent directly as unicast transmissions, as opposed to multicast probe messages and/or resolves. Other broadcast based protocols which do not multicast may perform discovery using a series of unicast polling messages to known nodes, thereby polling each one separately for a match (See FIG. 2).

Polling may consume considerable bandwidth in subnets that contain many services and/or requestors. As illustrated in FIG. 3, a single multicast message may be propagated in an exponentially increasing wave of transmissions between nodes in a network. In larger subnets, a broadcast storm may occur when too many requesters send probe and/or resolve messages at the same time. The storm may cause a network to become dysfunctional due to huge delays in message delivery or no message delivery when message packets collide. Some discovery protocols provide certain mechanisms to reduce the chance of a message storm. For example, some discovery protocols may implement a message wait trigger to create gaps in communications. In this situation, a service may be required to wait for a duration after detecting a request or response message from other services before transmitting its own message, thereby creating a gap communications.

Additionally, to minimize the need for polling, a discovery protocol may enable a target service to send an announcement to a multicast group announcing its presence upon joining a network. For example, when a service connects to a network, the service may announce its arrival by sending a Hello message 402. In one situation, these announcements may be sent across a network using multicast protocols. This process of sending announcements may reduce the need for polling on the network. By listening for announcements, clients may detect newly available target services without unnecessary probing. For example, when a client 440 receives an announcement, the client 440 may store the announcement, which may contain information similar to a probe match, and utilize that information to connect to a known service directly without probing. Also, when a target service leaves a network, the target service may make an effort to send a multicast Bye 414. A client 440 receiving a Bye message 414 may update its records accordingly, e.g., deleting a reference to the now unavailable service.

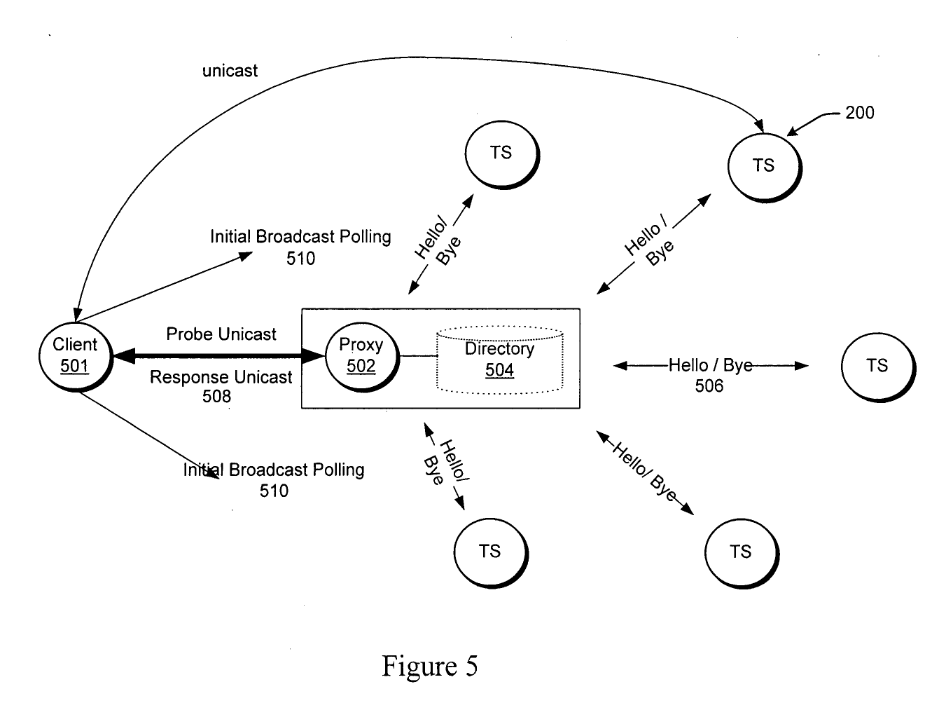

While service announcements and message wait triggers may help to reduce network traffic, large subnets may still suffer from a broadcast storm due to multicast probe and resolve transmissions. Thus, in order to limit the amount of network traffic and optimize the discovery process, some discovery protocols also implement a discovery proxy, as illustrated in FIG. 5. The WS-Discovery protocol may support a general hosted proxy 502, WS-Discovery proxy, that maintains a store 504 of discovered WS-Discovery services. The store may be populated based on service announcements, such as Hello and Bye messages 506 received by the proxy 502. The WS-Discovery proxy may then respond to discovery requests directly 508.

When a hosted proxy is newly installed, a client 501 may still operate in a broadcast only mode. In this case, the client may still transmit a multicast probe 510. However, instead of continuing to send network wide, broadcast resolution messages to discover services, a host may simply interact with the hosted proxy 502 to perform a discovery once it is aware of the proxy 502. For managed networks utilizing a discovery proxy, probes may be sent unicast 508 to the discovery proxy once the client is aware of a discovery proxy. The proxy 502 may reduce network traffic by storing discovery information so that multicasting discovery requests may not be needed.

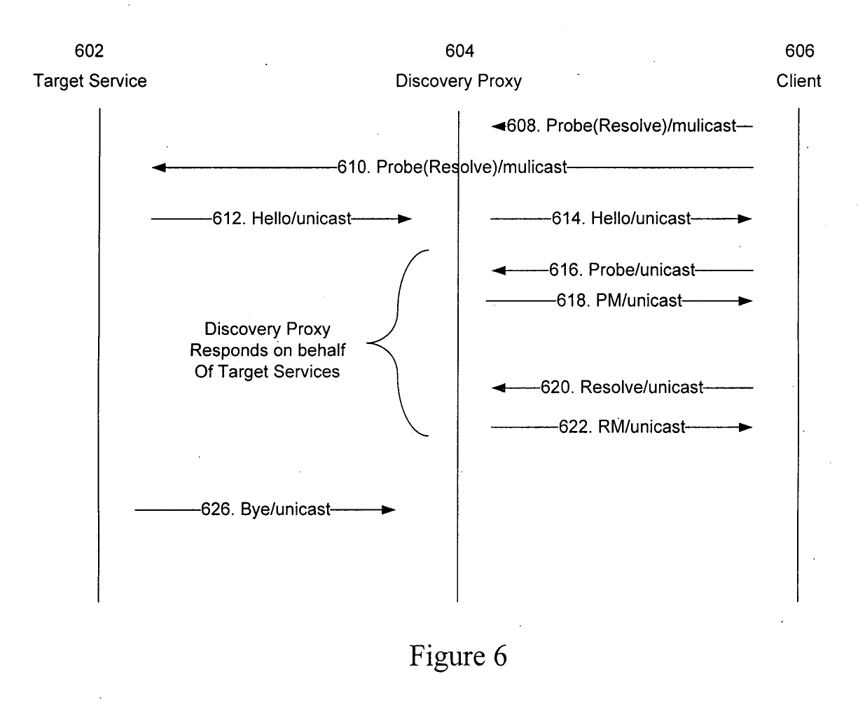

FIG. 6 illustrates a general WS-Discovery discovery process involving a discovery proxy. In this model, a target service 602 may continue to have the same functionality as in a non-proxy setting. In other words, the target service may be capable of sending multicast Hello and Bye, resolves and probes, and responses with unicast PM and RM. However, once the target service is registered with a discovery proxy, the discovery proxy may takeover responding to probe and resolve messages. The use of a proxy may effectively reduce client discovery requests to unicast messages to the proxy. When a hosted discovery proxy is installed, the discovery proxy may create a store of discovered services (See FIG. 5), which it may generate by listening for Hello multicasts 612. In a similar manner, as target services leave a network or become unavailable, the proxy may remove entries when it receives Bye messages 626. Alternatively, a discovery proxy may be pre-populated (by an administrator, for example) with a current list of network devices.

Because a discovery proxy may also be considered a service, a discovery proxy 604 may announce its presence with its own special Hello message 614. A client 606 receiving this message may then take advantage of the proxy's services, and the client 606 may no longer be required to send a network wide probe. Specifically, when a discovery proxy detects a probe or resolution request sent by multicast, the discovery proxy may send a Hello announcement for itself. By listening for these announcements, clients may detect discovery proxies and modify their behavior to use a discovery proxy. Additionally, network traffic may be further reduced by directing target services to send unicast Hello 612 and Bye 626 messages directly to a discovery proxy. A client may simply send a unicast probe 616 to a proxy 604 to perform discovery. The proxy 604 may then send back a unicast response 618. Similarly, a client 606 may send a unicast resolve 620 to a proxy 604 and the proxy 604 may return with a resolve match 622 with the necessary service information so that the client 606 may thereafter establish a direct link to the service 602. If a discovery proxy is unresponsive or otherwise becomes unavailable, clients may revert to using a standard broadcast resolution process, as described in FIG. 4.

It should be noted that some discovery protocols such as WS-Discovery may also allow for configurations where a probe message may be sent to a discovery proxy that has been established by some other administrative means, such as by using a well-known dynamic host configuration protocol (DHCP) record. In these situations where explicit network management services like DHCP, DNS, domain controllers, directories, etc., may be installed, the WS-Discovery specification may provide for situations where clients and/or target services may be configured to behave differently. For example, a specification may define a DHCP record containing the address of a discovery proxy, and compliance with that specification may require network entities to send messages to this discovery proxy rather than to a multicast group.

Broadcast based discovery protocols may suffer from expensive resource consumption. In this model, regardless of whether polling and/or resolution requests are transmitted multicast or unicast, several network entities may be required to process resolution requests. For example, even though a service may not be required to send a probe match in response to a probe, the service may still have to process a received probe to determine whether to respond. This processing may require CPU allocation for each device on the network. This communication also reduces network bandwidth and, with an increasing number of devices, message collisions may happen for frequently. There may also be the risk of a broadcast storm when too many devices are on the network and they all need to execute discovery process at the same time.

While implementation of discovery proxies may reduce network traffic, the use of discovery proxies may also entail cost. For example, a discovery proxy may typically require a server or dedicated device to host the proxy. For corporate networks having more than one subnet, a separate server/proxy may be needed for each subnet. Alternatively, a complex network configuration may be required to share a server proxy across multiple subnets. Additionally, there may be administrative costs associated with using a proxy. For example, an administrator(s) may be needed to configure and maintain the proxy server. Thus, between using a straight broadcast resolution process and a proxy server, there is a tradeoff between network efficiency and administrative work.

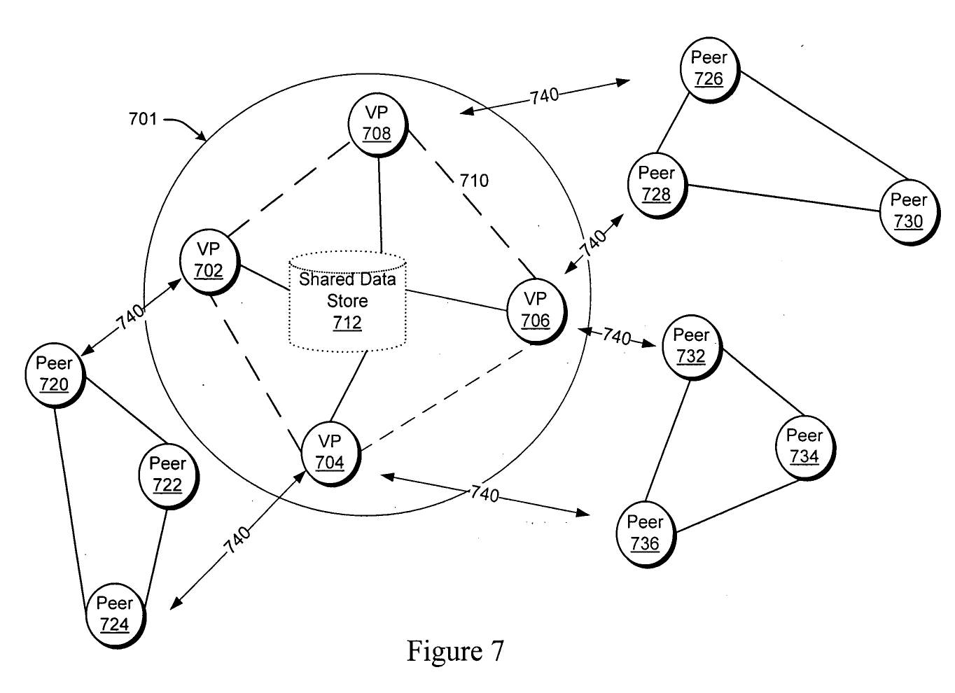

FIG. 7 illustrates a general system embodiment of ad hoc proxy or virtual proxy. A virtual proxy may be constructed from a set of hosts 702-708 that operate under a common overlay protocol (illustrated using dashed lines 710) and that use a shared data store 712. The set of hosts 702-708 may form a subnetwork 701 of hosts that may be capable of communicating with each other via the common overlay protocol 710 to maintain the shared data store of discovery information and to provide proxy services to both legacy entities 720-726 that are unable to participate in the subnetwork, as well as entities 702-708 that are part of the subnetwork forming the virtual proxy. The virtual proxy may provide a discovery proxy service using an existing discovery protocol 740, even though the virtual proxy may be composed of several host entities. The set of hosts 702-708 may be considered a virtual proxy or each one of the hosts (702, 704, 706 or 708) of the subnetwork may be considered a virtual proxy because each one of the proxies may be able to serve as a discovery proxy in a similar manner as any other host of the subnetwork. In other words, to a client (e.g., 732) on the network, any virtual proxy host of the subnetwork may appear to be the same virtual proxy because each virtual proxy host uses the same shared data store 712.

The virtual proxy may act as a single general discovery proxy for any client discovery request. In one embodiment, the virtual hosts may communicate over an overlay protocol different from the discovery protocol used to service discovery requests. The virtual hosts may use a first protocol for communicating data required to create and maintain the shared data store, and a second protocol for discovery. In one embodiment, the discovery protocol may be an existing discovery protocol such as WS-Discovery protocol or Simple Service Discovery Protocol (SSDP) and the overlay protocol may be a peer to peer overlay network or other protocol that may be capable of maintaining a shared data store among a group of hosts (to be discussed further below).

A shared data store may be used by the subnet of virtual proxy hosts to maintain a record of known or previously discovered services and/or devices and their corresponding access information. A shared data store may be a distributed data store maintained by a peer to peer graph or a replicated data store maintained by a group of networked devices using a file replication service (FRS) provided by a common operating system. Hosts that join a network of devices operating an FRS may automatically retrieve a copy of the distributed data store, where changes to any of the copies may be propagated to other copies maintained by the FRS. The file replication service may communicate using a protocol different from a discovery protocol.

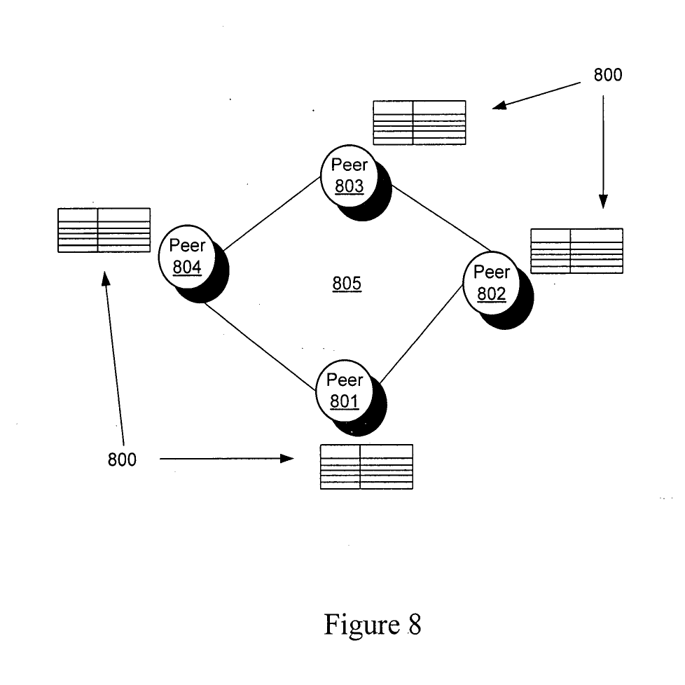

A peer to peer graph may represent a set of interconnected nodes. When a peer to peer graph maintains a distributed data store, each peer entity may only store and maintain a portion of the shared data store, hence the term distributed data store. In one embodiment, the distributed data store for a peer to peer graph may be divided between a group of peers using a hash function. FIG. 8 illustrates a general distributed hash table (DHT) which may be used in one embodiment. The distributed hash table 800 may be maintained over a group of peer entities 801-804 that form a peer-to-peer network 405. In this embodiment, the peer to peer network may form the virtual proxy. The entries in a distributed hash table may be logically divided or grouped using, for example, a hash function. The hash function may clump records together in some organized manner, thereby making retrieval more efficient. A DHT may have two primary properties: 1) distribution of a table (e.g., table 400), across a plurality of nodes (e.g., nodes 401-404); and 2) a routing mechanism (not shown) that provides a method for publishing and retrieving records. The routing mechanism and distribution may be managed by an overlay protocol such as Chord, Pastry, PNRP, Tapestry, etc.

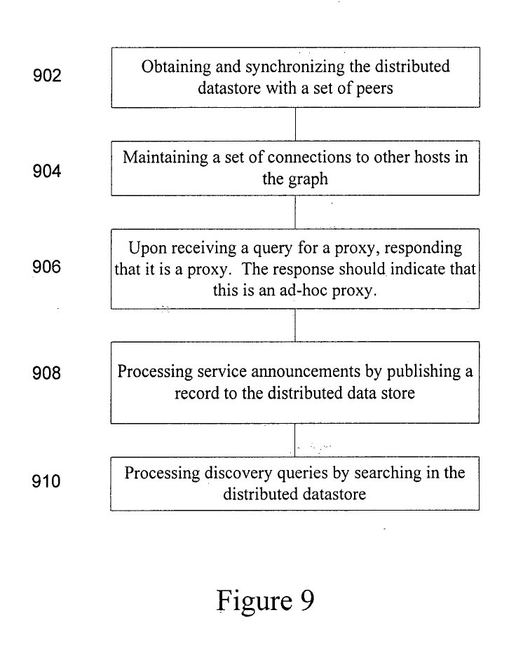

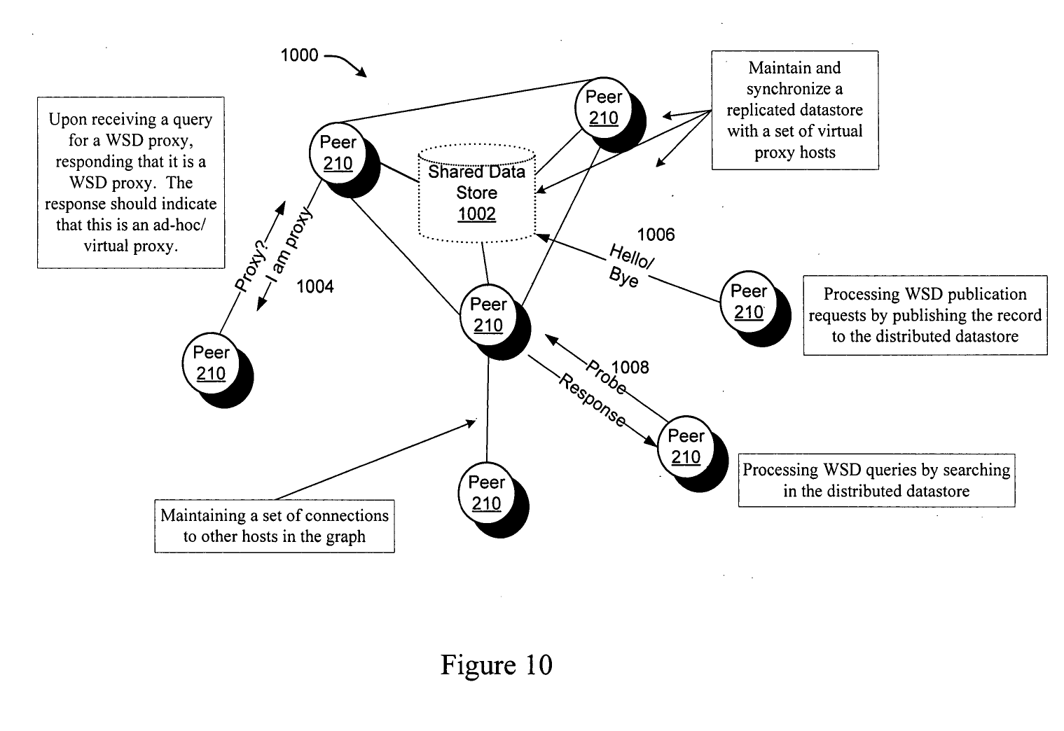

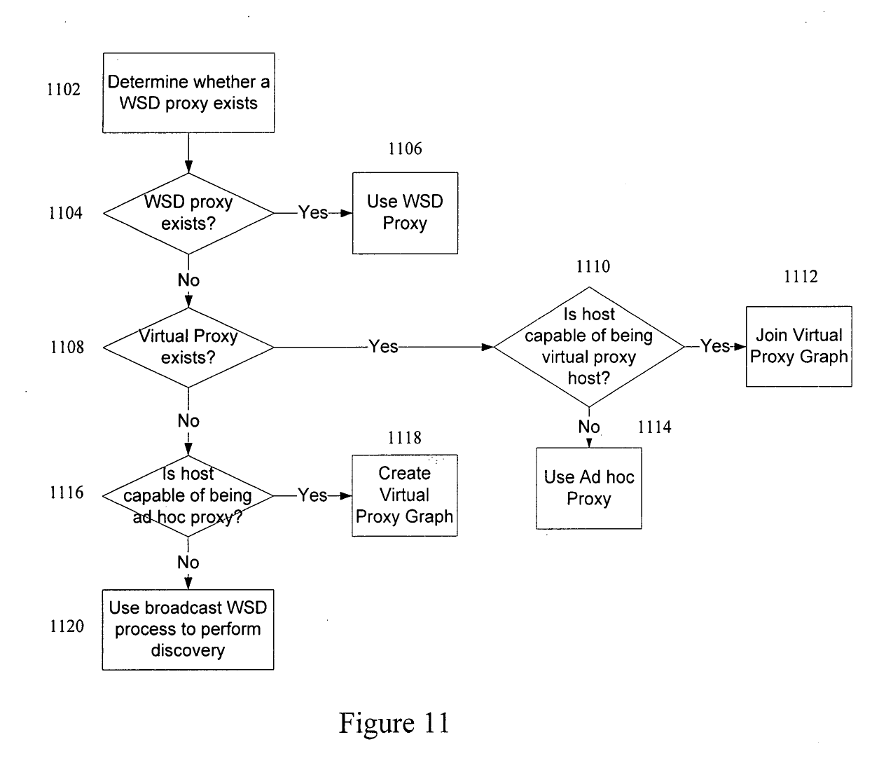

FIG. 9 illustrates that a virtual host may be characterized by performing the following actions: obtaining and synchronizing a shared data store with a set of peers 902; maintaining a set of connections to other virtual proxy hosts in a graph 904; responding that it is a proxy, upon receiving a discovery query 906; processing service announcements by publishing a record to or removing a record from the shared data store 908; and processing discovery queries by searching in the distributed data store and returning a response 910.

FIG. 10 illustrates one embodiment which uses WS-Discovery as the network discovery protocol and a replicated data store 1002 as a shared data store. The virtual host may operate using a file replication service to maintain a common replicated data store 1002. The virtual host may be responsible for maintaining a set of connections with other network entities. When a virtual proxy host receives a query for a proxy, the virtual proxy may respond that it is a proxy 1004. When a virtual proxy 1000 receives an announcement 1006, the virtual proxy 1000 may publish the record to the replicated data store 1002 (for Hello messages) or remove a record (for Bye messages). In one embodiment, data store records may expire unless they are refreshed by receiving new announcements 1006. When a virtual proxy host receives a query request 1008, the proxy may search the graph data store and respond accordingly.

As illustrated in FIG. 7 there may exist two types of network entities in a network. implementing a virtual proxy: those that may be aware of virtual proxy hosts 702-708 and are capable of becoming virtual proxy hosts and those that may be unaware of virtual proxies and are incapable of becoming a virtual proxy host, e.g., legacy devices 720-736. A legacy device may operate in a manner described above to send a probe to search for a general proxy. If a network implements a virtual proxy, the virtual proxy may announce itself as a proxy whose discovery services may be used by the legacy device. In this manner, legacy clients as well as virtual proxy hosts may be serviced by the virtual proxy system. A regular hosted proxy, as defined by an existing discovery protocol, may also be used instead of the virtual proxy.

FIG. 11 illustrates a process embodiment for a host joining a network capable of implementing a virtual proxy. When a host boots, the host may issue a query 1102 to determine whether a discovery proxy exists, as defined by a standard discovery protocol, e.g. a WS-Discovery proxy. This may be done via a query or poll (it should be noted that this process may be skipped if proxy information is available by other means, such as, for example, via DHCP response or DNS query). If a standard WS-Discovery proxy responds or is available 1104, then the host may thereafter use the proxy 1106. In this embodiment, a hosted WS-Discovery proxy may take priority over a virtual proxy. One reason for this may be that an administrator may be assumed to know whether devices on his network are capable of implementing a virtual proxy and that a manual implementation of a WS-Discovery proxy may indicate that the administrator is intentionally opting to use a manual proxy over a virtual proxy.

If a WS-Discovery proxy is not available, then a check may be made to determine if an ad-hoc/virtual proxy host is available 1108. (It should be noted that this check 1108 may be performed based on data obtained during the initial proxy query 1102, or it may require a second network query.) If there exists a virtual proxy host, then the new host may use the proxy 1114. Additionally, if the host is capable of being a virtual proxy host 1110, then the host may join the virtual proxy graph 1112. The process of connecting virtual proxy hosts may be called bootstrapping, where a set of virtual proxy peers build upon an existing graph whenever a new host joins a network. In one embodiment, the bootstrapping process may be a dynamic process facilitated by the underlying protocol. Using the underlying protocol, collections of proxy hosts may be linked together to scale a discovery service to a robust group of hosts, providing the capacity to service many clients with reduced broadcast traffic.

If no existing virtual proxy exists, then a check may be made to determine whether the host is capable of being a virtual proxy host 1116. If the host is capable of forming a virtual proxy host, the host may start a virtual proxy service by creating a sharable data store, creating a new graph of one host, and announcing that it is a virtual proxy 1118. Thereafter, the virtual proxy host may record announcements to generate a discovery service record and thereafter service future discovery requests as a virtual host. If the host is incapable of becoming a virtual proxy host, then the host may use standard broadcast polling 1120 as described above. The host may periodically issue requests to discover any proxies that may be made available to the network in the future.

In one embodiment, if a virtual proxy is established, the virtual proxy hosts may periodically check to determine whether a hosted WS-Discovery has been implemented. If such a hosted proxy is implemented, the virtual proxy hosts may cease performing as a virtual proxy. This may entail deconstructing the graph and removing the shared data store. Again, this may be done to ensure priority of a manually created, hosted discovery proxy over a virtual proxy.

A new host may determine whether an existing proxy is a virtual proxy in a number of ways. In one embodiment, a virtual proxy may include a flag or other information in a discovery response, such as a probe or resolve match, to indicate that it is a virtual proxy host. New hosts that are capable of being virtual proxy hosts may look for this flag and act accordingly once it detects that flag. For example, a virtual proxy capable host may join a network and be inactive as a proxy host for a period of time before creating its own graph. Once it receives a probe match from an existing proxy host it may then initiate the process of joining the existing virtual proxy graph.

In another embodiment, a host capable of being a virtual proxy may receive a discovery response or announcement from the network indicating that a proxy exists. In order to determine whether the proxy that sent the response is a standard hosted proxy or a virtual proxy, the new host may interrogate the proxy. For example, upon learning of the proxy via a discovery response or announcement, the new host may query the proxy. If the proxy is a virtual proxy, the virtual proxy may respond appropriately and upon receiving the response, the new host may join the existing virtual proxy graph. In an embodiment where a distributed data store is used as a shared data store, hosts that are capable of communicating using an overlay protocol may use functionality of the overlay protocol to determine whether a virtual proxy exists. For example, in a peer to peer network, a peer name resolution protocol may be used by a new host to determine whether a virtual host exists. This communication may be made outside of the discovery protocol. In one embodiment of this process, the overlay resolution approach may precede an interrogation process. In one embodiment, a new host may first attempt to use PNRP to determine a virtual proxy and then interrogate a proxy if the PNRP attempt fails.

The virtual proxy subnetwork may implement security provisions. For example, in one embodiment, the virtual proxy subnetwork may require authentication before a new host is able to join the virtual proxy graph. This may be called a secured virtual proxy versus a non-secured virtual proxy in which any host capable of joining the proxy graph may be allowed to join.

When there is more than one virtual proxy host in a network, some coordination may be required between the virtual proxy hosts to provide a proxy service. When a probe is received by a virtual host subnet, the probe may be handled in several ways. In one embodiment, when there is more than one proxy host available, each of the existing virtual proxy hosts may respond with a time out or time delay to the probe. This may help reduce the possibility of message overlap or collision. This process may be used where a client may be allowed to chose between more than one proxy. In another embodiment, a backoff process may be implemented. In this case, a virtual host that first receives the probe may send a response and other virtual hosts in the network may refrain from sending responses. In this case, the first virtual host may service the client. In another embodiment, when more than one virtual host exists in a network, an election process may be implemented where one virtual host is designated a primary host for responding to all discovery requests.

In another embodiment, determining which virtual host responds to a particular discovery request may be based on the distribution of records in the data share. This may be applicable in an embodiment where a distributed data store is used as the shared data store. As discussed above, a distributed data store, such as a DHT, may have records distributed amongst the peers maintaining the DHT. In one embodiment, whether a virtual proxy host responds may be based on whether the virtual proxy host is responsible for or stores the necessary resolution information to answer the probe. Thus, in this embodiment, a virtual proxy host that contains the records to resolve a discovery request may be designated to respond. This designation may be performed outside the discovery protocol (e.g., using the overlay protocol). Because the distribution of the records may correspond to the function used to distribute them, e.g., a hash function, the hash function may be used to direct a discovery request to the appropriate host node. This may be done via the discovery protocol. For example, a virtual host that first receives a unicast discovery request may determine the appropriate node and retransmit the unicast discovery request to the appropriate node, where the appropriate node then responds to the request.

In another embodiment, a virtual proxy host may respond to a probe as long as the proxy host is associated with the shared data store and is capable of accessing the records in the store. In this situation, the virtual proxy host may be responsible for locating the required data to resolve a message in the shared data store, regardless of whether the virtual host stores the required data portion. In such a case, the virtual proxy host may communicate with another virtual proxy host using an overlay protocol instead on the discovery protocol. For example, the virtual proxy host may communicate with another virtual proxy host that may store the portion of data via a peer to peer network protocol.

The claimed method and system shifts the burden of configuring and maintaining a proxy from a dedicated, administrator maintained server to a set of virtual proxy hosts that distribute and share a store of discovered services. A virtual proxy host may be dynamically created by introducing at least one host capable of forming a shared data store and servicing clients using the shared data store. These virtual proxy hosts may not need any dedicated server or administrator monitoring as they may be implemented via functionality included in an overlay protocol or replication service. As more virtual proxy hosts join a network, the proxy hosts may bootstrap one another to form a more robust proxy service. Moreover, because the subnet may have multiple endpoints in a network, clients may be more efficiently serviced by adjacent or closer nodes.

If a legacy client is part of a network that implements a virtual proxy host, then the client may not need to transmit multicast discovery requests, and instead rely on its access to the closest virtual proxy host. A legacy client may see the virtual host subnetwork as a standard discovery host and interact with one of the plurality of virtual hosts as if the virtual host was a standard hosted discovery proxy. If a client is a virtual proxy host, then the client may not need to use the discovery protocol to probe at all. The client may simply access its shared data store to obtain service addresses. Thus, using a virtual proxy host as described herein may enable a system to reduce network traffic while reducing administrative costs.

1. A method of providing a discovery proxy service for a network of devices comprising:
creating a sharable data store, wherein the sharable data store contains a record of discovered services;
associating the sharable data store with a first host;
responding to a client probe at the first host with a first probe match indicating that the first host is a discovery proxy; and
resolving a resolution request at the first host based on the sharable data store.

2. The method of claim 1, further comprising periodically determining whether a WS-Discovery proxy is available and foregoing responding to a client probe and resolving a resolution request by the first host when a WS-Discovery proxy is available.

3. The method of claim 1, further comprising receiving at the first host a second probe match from a second host associated with the sharable data store and responding to a client probe at the first host with a first probe match after a delay period from receiving the second probe match.

4. The method of claim 1, further comprising receiving at the first host a second probe match from a second host associated with the sharable data store and foregoing responding to a client probe at the first host with a first probe match upon receiving the second probe match.

5. The method of claim 1, further comprising determining by a second host whether the first host is associated with a sharable data store and associating a second host with the sharable data store if the first host is associated with the sharable data store.

6. The method of claim 5, wherein determining whether the first host is associated with a sharable data store comprises interrogating the first host by the second host upon receiving one of a hello message and a probe match from the first host.

7. The method of claim 5, wherein determining whether the first host is associated with a sharable data store comprises checking a probe match for an indication that the first host is associated with a sharable data store.

8. The method of claim 5, wherein determining whether the first host is associated with a sharable data store comprises initiating a peer name resolution protocol resolve process by the second host on the first host.

9. The method of claim 5, wherein responding to a client probe and resolving a resolution request is performed via a discovery protocol and creating a sharable data store and associating one of the first and second host with the sharable data store is performed via a second protocol different from the discovery protocol.

10. The method of claim 5, further comprising designating one of the first and second host entities to respond to a client probe with a probe match.

11. The method of claim 5, wherein the sharable data store is one of a distributed data store and a replicated data store.

12. The method of claim 11, further comprising designating one of the first and second host entities to resolve a resolution request based on a distribution of the data store.

13. A computer-readable medium having computer-executable instructions for performing operations comprising:
determining whether a first host is associated with a sharable data store and. associating a second host with the sharable data store if the first host is associated with a sharable data store, wherein the sharable data store contains a record of discovered services;
designating one of the first and second host to respond to one of a probe and resolve request; and
determining, periodically, whether a WS-Discovery proxy is available and foregoing responding to one of the probe and resolve requests by the first and second host when a WS-Discovery proxy is available.

14. The computer-readable medium of claim 13, wherein the sharable data store is a distributed hash table and designating one of the first and second host to respond to one of a probe and resolve request is based on a hash of the record of discovered services.

15. The computer-readable medium of claim 13, wherein the distributed hash table is operated via a peer-to-peer network.

16. A system comprising:
a network of devices communicating over a discovery protocol;
a client device that broadcasts one of a probe and resolve message to the network;
a sharable data store containing a record of discovered services on the network;
a first host device that stores a portion of the sharable data store and a second host device that stores a second portion of the sharable data store, and wherein one of the first host and second host responds to one of the probe and resolve messages via the discovery protocol.

17. The system of claim 16, further comprising a third host that is a WS-Discovery proxy and wherein the first host ceases to service client probes and resolution requests upon determining that the third host is a WS-Discovery proxy.

18. The system of claim 16, wherein the first host communicates with the second host via a second protocol separate from the discovery protocol to coordinate responses to probe and resolve messages.

19. The system of claim 16, wherein the first and second portions are determined by a hash function.

20. The system of claim 19, wherein one of the first host and second host responds to one of the probe and resolve messages based on the hash function.
